(19) United States
(12) Patent Application Publication
(10) Pub. No.: US 2023/0133997 A1
(43) Pub. Date: May 4, 2023

(54) Marker pen with replaceable marker cartridge

(71) Applicant: Common Understanding, Inc., Aliso Viejo, CA (US)

(72) Inventors: Wilson Mefford, Somerville, MA (US); Robert Christiansen, Laguna Hills, CA (US); Devon Wayt, Mission Viejo, CA (US)

(21) Appl. No.: 17/905,920

(22) PCT Filed: Apr. 7, 2021
(86) PCT No.: PCT/US2021/026198

§ 371 Date: Sep. 8, 2022

Related U.S. Application Data
(60) Provisional application No. 63/006,310, filed on Apr. 7, 2020.

(51) Int. Cl. B43K 8/03; B43K 8/02

(52) U.S. Cl. CPC B43K 8/03; B43K 8/022

(57) ABSTRACT

Devices including a marker pen body, a marker cartridge, and a kit having the marker pen body and at least one marker cartridge. The marker pen includes a marker pen body front and a marker pen body rear configured to removably mate with the marker pen body front, the mated marker pen body front and the marker pen body rear forming a cavity having an interior mating means configured to removably mate with a cartridge and prevent rotation of the cartridge in the cavity. The cartridge includes a nib, a marker cartridge housing including an exterior mating means configured to removably mate with a cavity of a marker pen body, such that removably mating the exterior mating means and the cavity is configured to prevent rotation of the marker cartridge housing in the cavity, and a sponge configured to contact the nib inside the marker cartridge housing and transfer ink to the nib.

### CROSS REFERENCE TO RELATED APPLICATIONS

The present application claims the benefit of each of co-pending U.S. provisional application No. 63/006,310, filed on Apr. 7, 2020 and United States design patent application No. 29/738,597, filed on Jun. 18, 2020, the entire disclosure of each of which is incorporated by reference as if set forth in their entirety herein.

### TECHNICAL FIELD

Embodiments described herein generally relate to marker pens and, more particularly but not exclusively, to making marker pen bodies with replaceable marker cartridges.

### BACKGROUND

Marker pens are widely used in personal, business, and academic settings throughout the world. While these marker pens are useful tools, their single-use nature causes over 500 million markers to be disposed of every year. The disposable nature of marker pens is reinforced by their low quality, short life, and poor performance. A single disposable marker weighs 30% more than a plastic water bottle and decomposes at a much lower rate. The net result is over 17 million pounds of plastic dumped into overburdened landfills.

Several attempts have been made to establish a refillable marker. A common design is to include a liquid ink reservoir which continually supplies the nib with ink as the user writes. While this design allows the marker body to be reused by refilling the reservoir, it requires the user to handle vials of liquid ink. This can lead to ink spills and stains which cause some users to shy away from this option. Another common design is to allow the user to re-saturate depleted ink sponges with a liquid ink to extend the life of the marker. However, this method takes a significant amount of time which is unacceptable when it would be much easier to throw out the marker and grab a new one.

Another challenge with a disposable marker is the short life span of the fiber tip, referred to as a nib. One of the contributing factors to the disposable nature of the marker is the inability to replace the nib once it has lost its form. In current designs, nib replacement is often impossible without destroying the pen. Of the markers that do afford nib replacement, the process is messy, difficult, and inconvenient.

A need exists, therefore, for improved marker housing and replaceable marker cartridges.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a marker pen body. The marker pen body includes a marker pen body front; and a marker pen body rear configured to removably mate with the marker pen body front, the mated marker pen body front and the marker pen body rear forming a cavity having an interior mating means configured to removably mate with a cartridge and prevent rotation of the cartridge in the cavity.

In some embodiments, the marker pen body further includes a cap configured to removably connect to the marker pen body front.

In some embodiments, the cap is configured to snap-fit onto the marker pen body front.

In some embodiments, the marker pen body rear is configured to removably mate with the marker pen body front using a screw thread.

In some embodiments, the interior mating means comprises at least two parallel ribs.

In some embodiments, the at least two ribs and extend along more than half of the length of the marker pen body front.

In some embodiments, the interior mating means comprises at least four parallel ribs extending along the length of the marker pen body front.

In some embodiments, the interior mating means comprises at least one indent in the interior of the marker pen body rear.

In some embodiments, the marker pen body front has a female mating means configured to removably mate with a male mating means of the marker pen body rear.

In some embodiments, the marker pen body rear comprises a male mating means configured to removably mate with a cap.

In another aspect, embodiments relate to a marker cartridge. The marker cartridge includes a nib; a marker cartridge housing comprising an exterior mating means configured to removably mate with a cavity of a marker pen body, such that removably mating the exterior mating means and the cavity is configured to prevent rotation of the marker cartridge housing in the cavity; and a sponge configured to contact the nib inside the marker cartridge housing and transfer ink to the nib.

In some embodiments, the marker cartridge housing is configured to restrict air flow to the sponge and the nib.

In some embodiments, the exterior mating means comprises at least two slots extending along the length of the marker cartridge housing.

In some embodiments, the exterior mating means comprises at least four slots extending along the length of the marker cartridge housing.

In some embodiments, the nib is a dry erase nib.

In some embodiments, at least one of the nib or the sponge comprises a silicon polymer.

In some embodiments, the marker cartridge housing comprises a plastic polymer.

In some embodiments, the nib is configured to be removably mated to the marker cartridge housing and the sponge.

In yet another aspect, embodiments relate to a marker pen kit. The marker pen kit includes a marker pen body front; a marker pen body rear configured to removably mate with the marker pen body front, the mated marker pen body front and the marker pen body rear forming a cavity having an interior mating means; and a marker cartridge including a nib; a marker cartridge housing comprising an exterior mating means configured to removably mate with the interior mating means, such that removably mating the interior mating means and the exterior mating means is configured to prevent rotation of the marker cartridge housing in the cavity; and a sponge configured to contact the nib inside the marker cartridge housing and transfer ink to the nib.

In some embodiments, the exterior mating means comprises at least two slots extending along the length of the marker cartridge housing.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a marker pen with a replaceable marker cartridge in accordance with one embodiment;

FIG. 2 illustrates an exploded view of a marker pen body and a replaceable marker cartridge in accordance with one embodiment;

FIG. 3 illustrates a marker pen body with a cap in accordance with one embodiment;

FIG. 4 illustrates a marker cartridge in accordance with one embodiment;

FIG. 5 illustrates a cross-section of a marker pen body and a replaceable marker cartridge in accordance with one embodiment;

FIG. 6 illustrates a cross-section of an exploded view of a marker pen body in accordance with one embodiment; and

FIG. 7 illustrates a marker cartridge loaded in a marker pen body in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques, and implementations of the present disclosure to those skilled in the art. Embodiments may be practiced as methods, systems, or devices. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The embodiments described herein address the shortcomings of existing marker pens. The result is a marker pen configured to be refilled by a user. The marker pen comprises an exterior marker structure, referred to as a marker pen body, and a replaceable marker cartridge. The marker pen body comprises a marker pen body front and a marker pen body rear. In some embodiments, the marker pen body also comprises a cap configured to attach to the marker pen body front and cover an installed cartridge to prevent the cartridge from drying. The marker pen body front, the marker pen body rear, and the optional cap are configured to be separable by a user.

In some embodiments, the marker cartridge also comprises a plurality of components. The cartridge may comprise a marker cartridge housing, a writing nib, and a sponge configured to hold marker ink. In some embodiments, the components may be removably mated to each other and separable by a user. In some embodiments, the components may be permanently affixed to each other, such that a user cannot easily reversibly disassemble the cartridge.

In some embodiments, the marker cartridge and the marker pen body may have mating features that facilitate the replacement and installation of a new replaceable marker cartridge, while preventing the installation of incompatible marker cartridges into the marker pen body.

In some embodiments, the marker pen body may be in a kit with at least one marker cartridge. In some embodiments, the marker pen body may be included in a kit with a plurality of marker cartridges. In some embodiments, a plurality of marker cartridges may be sold as a kit. In some embodiments, the plurality of marker cartridges comprises different ink colors.

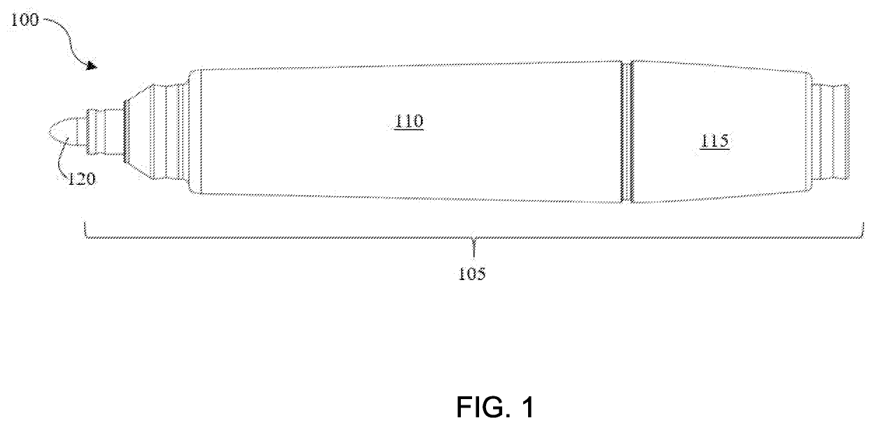

FIG. 1 illustrates a marker pen 100 with a replaceable marker cartridge in accordance with one embodiment. The marker pen 100 comprises a marker pen body 105, having a marker pen body front 110 and a marker pen body rear 115. In some embodiments, the marker pen 100 has a writing nib 120. The writing nib 120 may be soft and configured to use on dry erase surfaces. The writing nib may include ink encapsulated in a replaceable marker cartridge within the marker pen body 105. In some embodiments, the writing nib 120 may be a dry erase nib having a silicon polymer as ink. The marker pen body 105 may be configured such that, when the marker cartridge is installed within the marker pen body 105, only the writing nib 120 of the marker cartridge may be visible to the user.

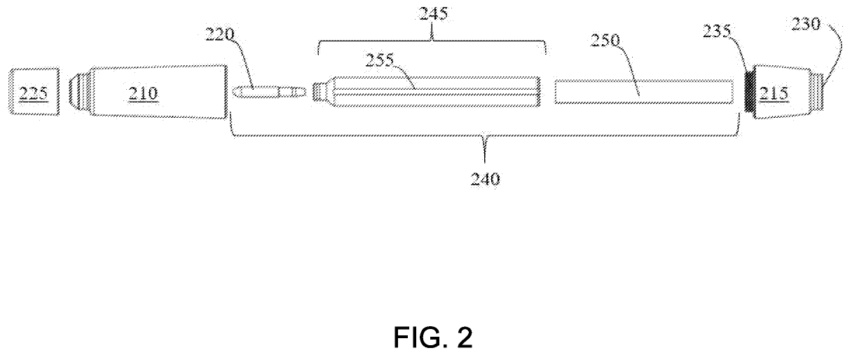

FIG. 2 illustrates an exploded view of a marker pen body and a replaceable marker cartridge in accordance with one embodiment. In some embodiments, the marker pen body comprises a marker pen body front 210 and a marker pen body rear 215 configured to removably mate with the marker pen body front 210. The marker pen body may also comprise a cap 225 configured to removably mate with the marker pen body front 210. The cap 225 may also be configured to removably mate with the end 230 of the marker pen body rear 215 opposite to the end 235 configured to removably mate with the marker pen body front 210. For example, the cap 225 may be configured to reversibly snap fit onto at least one of the marker pen body front 210 or marker pen body rear 215. In some embodiments, the cap 225 may be configured to encapsulate the writing nib 220 of the marker cartridge 240 to restrict airflow to the writing nib 220 and prevent the writing nib 220 from drying out due to air exposure.

In some embodiments, the replaceable marker cartridge 240 may comprise a writing nib 220, a marker cartridge housing 245, and a sponge 250. In some embodiments, the sponge 250 is configured to fit inside the marker cartridge housing 245 and contact the writing nib 220. When in contact with the writing nib 220, the sponge 250 may be configured to transfer ink into the writing nib 220 in some embodiments.

In some embodiments, when the marker pen body front 210 removably mates with the marker pen body rear 215, the mated marker pen body forms a cavity. The replaceable marker cartridge 240, comprising the marker cartridge housing 245, the writing nib 220, and the sponge 250, may be configured to fit primarily within the cavity. In some embodiments, the sponge 250 may be configured to fit entirely within the cavity and entirely within the marker cartridge housing 245. The writing nib 220 of the marker cartridge 240 may be configured to protrude beyond the marker cartridge housing 245 and beyond the cavity, such that a user can hold the marker pen body and write with the ink in the writing nib 220. When the marker cartridge 240 is dry or no longer writes properly, a user may uncouple the marker pen body front 210 from the marker pen body rear 215, remove the marker cartridge 240, and replace the marker cartridge 240.

In some embodiments, the marker cartridge housing 245 may include concave features 255 configured to mate with convex features on the inside of the marker pen body. In some embodiments, mating the concave features 255 with the convex features may prevent rotation of the marker cartridge 240 within the marker pen body. In other embodiments, the marker cartridge housing 245 may include convex features (not shown) configured to mate with concave features on the inside of the marker pen body (not shown) so as to prevent rotation of the marker cartridge 240 within the marker pen body.

In some embodiment, the marker cartridge housing 245 may comprise a recyclable polymer. In some embodiments, the marker cartridge housing 245 may comprise a plastic polymer. In some embodiments, the sponge 250 and writing nib 220 may be removed from the marker cartridge housing 245 to facilitate recycling of the marker cartridge housing 245. In some embodiments, the sponge 250, writing nib 220, and the marker cartridge housing 245 are all recyclable.

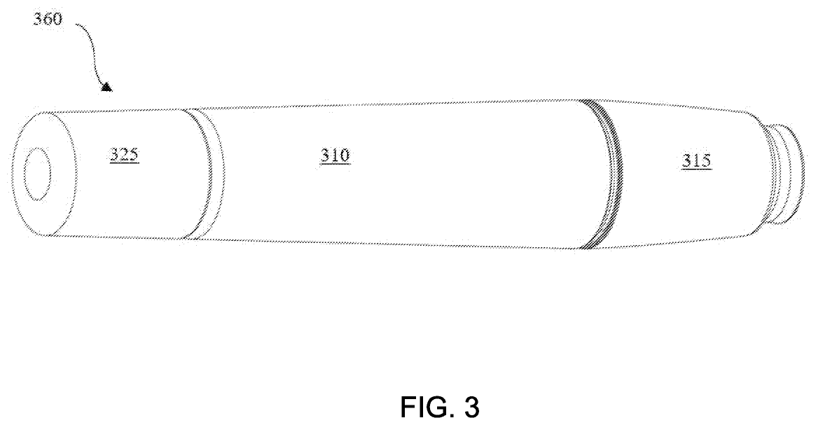

FIG. 3 illustrates a marker pen body 360 with a cap 325 in accordance with one embodiment. In some embodiments, the cap 325 may be configured to seal off the writing nib from the external environment to prevent the writing nib from drying out. In some embodiments, the seal between the cap 325 and the marker pen body front 310 may be airtight. In some embodiments, the seal between the cap 325 and the marker pen body front 310 may be watertight. In some embodiments, the marker pen body 360 may comprise a recyclable polymer. In some embodiments, the marker pen body 360 may comprise a plastic polymer. In some embodiments, the marker pen body 360 may comprise the same material as the marker cartridge housing.

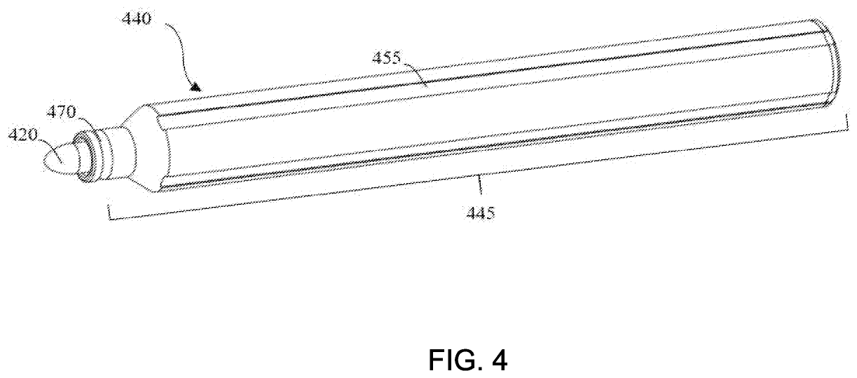

FIG. 4 illustrates a marker cartridge 440 in accordance with one embodiment. In some embodiments, the marker cartridge may have an exterior mating means 455 configured to removably mate with the marker pen body. In some embodiments, the exterior mating means 455 may be convex features, concave features, or a combination of convex and concave features. In some embodiments, the exterior mating means 455 may include only concave features. In some embodiments, the exterior mating means 455 may be female rib-like extensions. In some embodiments, these may be parallel slots. In some embodiments, the marker cartridge housing 445 may comprise a plurality of exterior mating means 455. The marker cartridge housing 445 may comprise at least two concave features, at least four concave features, at least six concave features, or at least eight concave features as the exterior mating means 455 in some embodiments. In some embodiments, the exterior mating means 455 may be identical features and may run parallel along the length of the marker cartridge housing 445. In some embodiments, the exterior mating means 455 may have different lengths. The exterior mating means 455 may extend along at least the front part of the marker cartridge housing 445. In some embodiments, the exterior mating means 455 are compatible with mating means of the marker pen body, such that the mating means prevents the use of incompatible cartridges. In some embodiments, the exterior mating means 455 may comprise indentation slots, such that the mating means 455 are grooves in the marker cartridge housing 445 extending a depth equal to the depth of the mating means of the marker body pen (not shown). In some embodiments, the mating means 455 may comprise at least one cavity extending through the marker cartridge housing 445.

In some embodiments, the marker cartridge 440 may comprise a feature 470 which allows the writing nib 420 to be sealed off from the external environment, preventing the writing nib 420 from drying out by restricting airflow to the sponge and writing nib 220. In some embodiments, the feature may only seal part of the writing nib 420 within the marker cartridge housing 445.

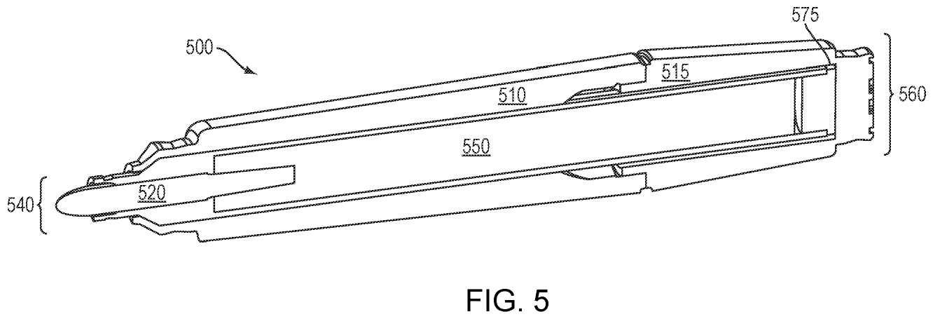

FIG. 5 illustrates a cross-section 500 of a marker pen body 560 and a replaceable marker cartridge 540 in accordance with one embodiment. In some embodiments, the marker pen body 560 and the replaceable marker cartridge 540 are configured to removably mate. In some embodiments, the replaceable marker cartridge 540 is configured to snap into the marker pen body 560. When the writing nib 520 of the replaceable marker pen cartridge 540 fails to write, a user may remove the replaceable marker cartridge 540 and install a new replaceable marker cartridge 540 within the marker pen body 560 in some embodiments.

In some embodiments, to remove the replaceable marker cartridge 540, a user may unscrew or otherwise uncouple the marker pen body rear 515 from the marker pen body front 510. The user may then pull the replaceable marker cartridge 540 from the marker pen body front 510, separating the replaceable marker cartridge 540 from the marker pen body front 510. After replacing the replaceable marker cartridge 540, the user may then screw or otherwise couple the marker pen body rear 515 to the marker pen body front 510, containing the replaceable marker cartridge in the cavity of the marker pen body 560.

In some embodiments, the marker pen body rear 515 may have at least one indent 575 configured to reversibly mate with the replaceable marker cartridge 540.

In some embodiments, the writing nib 520 fits within the sponge 550 of the replaceable marker cartridge 540. In some embodiments, the contact between the sponge 550 and the writing nib 520 allows the writing nib 520 to draw ink from the sponge 550 and direct the ink from the base of the writing nib 520 to the tip of the writing nib 520.

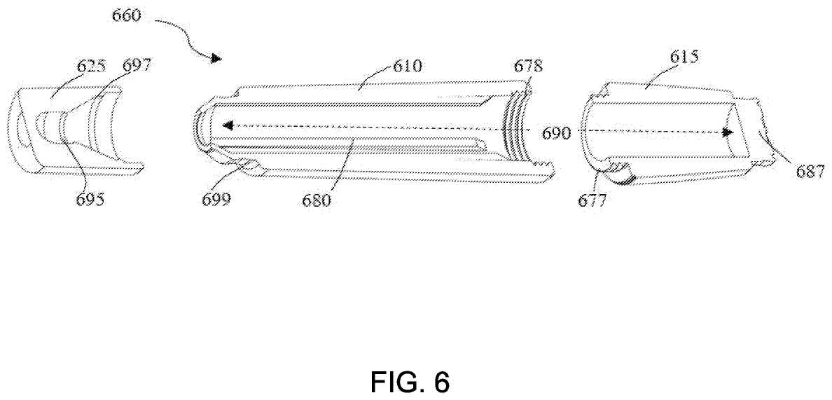

FIG. 6 illustrates a cross-section of an exploded view of a marker pen body 660 in accordance with one embodiment. The marker pen body 660 may include at least one mating means 680 configured to removably mate with the marker cartridge. In some embodiments, the marker pen body 660 may comprise a plurality of interior mating means 680 within the cavity 690. In some embodiments, the mating means 680 may comprise male, rib-like extensions 680 running parallel along the inside of the marker pen body front 610. In some embodiments, the mating means 680 may comprise female male, rib-like extensions running parallel along the inside of the marker pen body front. In some embodiments, the marker pen body front 610 may comprise at least two convex features, at least four convex features, at least six convex features, or at least eight convex features as the interior mating means 680 in some embodiments. In some embodiments, the interior mating means 680 may be identical features and may run parallel along the length of the marker pen body front 610. In some embodiments, the interior mating means 680 may have different lengths. In some embodiments, all interior mating 680 means may extend along more than half of the length of the marker pen body front 610. In some embodiments, the mating means 680 may include parallel and perpendicular segments (not shown), requiring the marker cartridge to be rotated as it is loaded into the marker pen body 660.

In some embodiments, the mating means 680 may be compatible with exterior mating means of the marker cartridge, such that the mating means 680 prevents the use of incompatible cartridges. For example, if the marker cartridge comprises two female rib-like extensions as mating means, the marker pen body front 610 may comprise two male rib-like extensions configured to fit the female rib-like extensions as mating means 680. In some embodiments, the marker pen body rear 615 may comprise a mating means instead of or in addition to the mating means 680 of the marker pen body front 610.

In some embodiments, the cap 625 may comprise a concave feature 695 inside the cap. When the user desires to seal off the writing nib of the marker cartridge from the external environment to prevent the writing nib from drying out, the cap 625 may be placed over the writing nib and may create a seal with the concave feature 695 and the marker pen body front 610 prevent the writing nib from drying out.

In some embodiments, the cap 625 may comprise a convex feature 697 inside the cap 625. When the user desires to seal off the writing nib of the marker cartridge from the external environment to prevent the writing nib from drying out, the cap 625 may be placed over the writing nib, reversibly mating the convex feature 697 inside the cap 625 with a concave feature 699 on the exterior of the marker pen body front 610. The reversible mating of the cap 625 and the marker pen body front 610 may create a seal prevent the writing nib from drying out.

In some embodiments, the marker pen body rear 615 may comprise a male mating means 687 configured to removably mate with the cap 625. When a user is writing with the marker pen, the user may couple the cap 625 to the marker pen body rear 615 at the male mating means 687.

In some embodiments, the marker pen body rear 615 may have a male mating means 677 configured to couple with the marker pen body front 610. In some embodiments, the marker pen body rear 615 may have a female mating means configured to couple with the marker pen body front 610. In some embodiments, the marker pen body front 610 may reversibly couple to the marker pen body rear 615 with a screw thread. In some embodiments, the marker pen body rear 615 may have a screw top 677 configured to screw into the female screw mating means 678 of the marker pen body front 610. In some embodiments, the marker pen body front 610 may have a screw top configured to screw into the female screw mating means of the marker pen body rear 615.

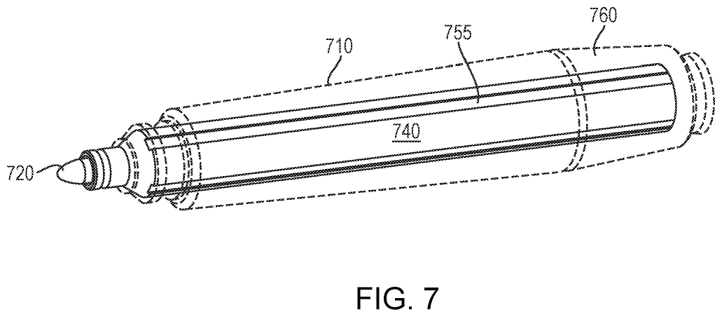

FIG. 7 illustrates a marker cartridge 740 loaded in a marker pen body 760 in accordance with one embodiment. In some embodiments, the mating means within the cavity of the marker pen body 760 are configured to removably mate with the mating means 755 of the marker cartridge 740 and prevent rotation of the marker cartridge 740 after being secured in the marker pen body 760. In some embodiments, when the marker cartridge 740 is loaded into the marker pen body 760, at least part of the writing nib 720 is configured to protrude from the marker pen body front 710.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A marker pen body comprising:
a marker pen body front; and
a marker pen body rear configured to removably mate with the marker pen body front, the mated marker pen body front and the marker pen body rear forming a cavity having an interior mating means configured to removably mate with a cartridge and prevent rotation of the cartridge in the cavity.

2. The marker pen body of claim 1, further comprising a cap configured to removably connect to the marker pen body front.

3. The marker pen body of claim 2, wherein the cap is configured to snap-fit onto the marker pen body front.

4. The marker pen body of claim 1, wherein the marker pen body rear is configured to removably mate with the marker pen body front using a screw thread.

5. The marker pen body of claim 1, wherein the interior mating means comprises at least two parallel ribs.

6. The marker pen body of claim 5, wherein the at least two ribs and extend along more than half of the length of the marker pen body front.

7. The marker pen body of claim 1, wherein the interior mating means comprises at least four parallel ribs extending along the length of the marker pen body front.

8. The marker pen body of claim 1, wherein the interior mating means comprises at least one indent in the interior of the marker pen body rear.

9. The marker pen body of claim 1, wherein the marker pen body front has a female mating means configured to removably mate with a male mating means of the marker pen body rear.

10. The marker pen body of claim 1, wherein the marker pen body rear comprises a male mating means configured to removably mate with a cap.

11. A marker cartridge comprising:
a nib;
a marker cartridge housing comprising an exterior mating means configured to removably mate with a cavity of a marker pen body, such that removably mating the exterior mating means and the cavity is configured to prevent rotation of the marker cartridge housing in the cavity; and
a sponge configured to contact the nib inside the marker cartridge housing and transfer ink to the nib.

12. The marker cartridge of claim 11, wherein the marker cartridge housing is configured to restrict air flow to the sponge and the nib.

13. The marker cartridge of claim 11, wherein the exterior mating means comprises at least two slots extending along the length of the marker cartridge housing.

14. The marker cartridge of claim 11, wherein the exterior mating means comprises at least four slots extending along the length of the marker cartridge housing.

15. The marker cartridge of claim 11, wherein the nib is a dry erase nib.

16. The marker cartridge of claim 11, wherein at least one of the nib or the sponge comprises a silicon polymer.

17. The marker cartridge of claim 11, wherein the marker cartridge housing comprises a plastic polymer.

18. The marker cartridge of claim 11, wherein the nib is configured to be removably mated to the marker cartridge housing and the sponge.

19. A marker pen kit comprising:
a marker pen body front;
a marker pen body rear configured to removably mate with the marker pen body front, the mated marker pen body front and the marker pen body rear forming a cavity having an interior mating means; and
a marker cartridge comprising:
a nib;
a marker cartridge housing comprising an exterior mating means configured to removably mate with the interior mating means, such that removably mating the interior mating means and the exterior mating means is configured to prevent rotation of the marker cartridge housing in the cavity; and
a sponge configured to contact the nib inside the marker cartridge housing and transfer ink to the nib.

20. The marker pen kit of claim 19, wherein the exterior mating means comprises at least two slots extending along the length of the marker cartridge housing.
